(19) United States
(12) Patent Application Publication
(10) Pub. No.: US 2023/0065390 A1
(43) Pub. Date: Mar. 2, 2023

(54) COVER BOARD WITH REINFORCING LAYER

(71) Applicant: BMIC LLC, Dallas, TX (US)

(72) Inventors: Jason Jones, Tustin, CA (US); Kenneth Lloyd Willoughby, JR., Wills Point, TX (US); Paul C. Lem, Mountain Lakes, NJ (US); Lingtao Yu, Summit, NJ (US); Trieu Nguyen, Plano, TX (US)

(21) Appl. No.: 17/894,556

(22) Filed: Aug. 24, 2022

Related U.S. Application Data
(60) Provisional application No. 63/236,913, filed on Aug. 25, 2021.

(51) Int. Cl. E04D 11/02; E04C 2/26; E04C 2/52; B32B 27/40; B32B 5/02; B32B 27/32; B32B 27/30; B32B 25/16; B32B 27/12; B32B 5/26; B32B 7/12; B32B 37/20; B32B 25/10

(52) U.S. Cl. CPC E04D 11/02; E04C 2/26; E04C 2/526; B32B 27/40; B32B 5/028; B32B 27/32; B32B 27/304; B32B 25/16; B32B 27/12; B32B 5/26; B32B 7/12; B32B 37/203; B32B 25/10; B32B 5/024; B32B 5/022; B32B 2419/06; B32B 2307/304; B32B 2307/558; B32B 2262/0276; B32B 2262/101; B32B 2262/156; B32B 2262/0261; B32B 2262/0253; B32B 2255/02; B32B 2255/26; B32B 2375/00; B32B 2323/00; B32B 2327/06; B32B 2319/00; B32B 2305/18; B32B 2305/188; B32B 2305/20; B32B 2315/08; B32B 2377/00; B32B 2367/00; B32B 2307/7265

(57) ABSTRACT

A cover board and roofing system including a cover board are disclosed. In one embodiment, the cover board includes a core having a first surface and a second surface. The core is configured to overlie a roof substrate. The cover board includes at least one facer attached to the first surface, the second surface, or both the first surface and second surface of the core. The cover board includes a reinforcing layer positioned between the core and the at least one facer. The reinforcing layer may comprise a scrim material. An impact resistance of the cover board may be greater than an impact resistance of an identical cover board without the scrim material.

### REFERENCE TO RELATED APPLICATION

The present Patent application claims the benefit of U.S. Provisional Application No. 63/236,913, filed Aug. 25, 2021.

### INCORPORATION BY REFERENCE

The disclosures made in U.S. Provisional Application No. 63/236,913, filed Aug. 25, 2021, are specifically incorporated by reference herein as if set forth in its entirety.

### TECHNICAL FIELD

This disclosure relates generally to roofing systems and more particularly to roofing systems having cover boards reinforced to resist impacts.

### BACKGROUND

Cover boards are a common failure point for single ply roofing systems that may be exposed to hail, and particularly when exposed to very severe hail. Insurers have created specific testing requirements for hail resistant roofing systems, including, for example, for a “Very Severe Hail” (VSH) classification, under the FM Approvals ANSI/FM 4470 VSH impact resistance testing standard for very severe hail resistance, roofing systems must withstand 2-inch ice balls propelled at 152-160 feet per second, resulting in an impact energy of 53-58 ft. lbs. Damage to cover boards due to hail or other impacts may further result in damaged insulation panels or damage to other layers of the roofing system. Such damage to insulation panels and/or other components of the roofing system due to hail and other substantial impacts typically will require replacement of such components, and may cause additional issues if left alone, e.g., water damage from potential water intrusion or ingress through damaged areas.

Accordingly, it can be seen that needs exist for cover boards and roofing systems utilizing such cover boards that can provide resistance to very severe hail and/or other types or levels of impact resistance. The present disclosure addresses these and other related and unrelated issues.

### SUMMARY

Briefly described, according to aspects of the present disclosure, a roofing system is provided, the roofing system including a cover board comprising a core with a first surface and second surface. The core of the cover board is configured to overlie a roof substrate of the roofing system. In embodiments, at least one facer is attached to the first surface and/or the second surface of the core; and a reinforcing layer is positioned between the core and the at least one facer. In embodiments, the reinforcing layer comprises a scrim material configured to provide the cover board with an impact resistance greater than an impact resistance of an identical cover board without the reinforcing layer.

Various aspects of a cover board or roofing systems and methods therefore are disclosed, including without limitation a cover board, comprising a core having a first surface and a second surface, the core configured to overlie a roof substrate; at least one facer attached to the first surface, the second surface, or the first surface and second surface of the core; and a reinforcing layer positioned between the core and the at least one facer; wherein the reinforcing layer comprises a scrim material; wherein the scrim material comprises a woven material, non-woven material, mesh material, or combination thereof, and wherein an impact resistance of the cover board is greater than an impact resistance of an identical cover board without the scrim material.

In embodiments of the cover board, when the cover board is installed on a roof substrate to form a roofing system, the roofing system meets FM Approvals ANSI/FM 4470 VSH impact resistance testing standard for very severe hail resistance.

In embodiments of the cover board, the scrim material comprises a denier of at least 1000×1000 denier.

In embodiments of the cover board, the scrim material comprises a side-by-side pattern, over/under pattern, tri-directional pattern, quad-directional pattern, or combinations thereof.

In embodiments of the cover board, the reinforcing layer further comprises a substrate attached to the scrim material.

In some embodiments of the cover board, the substrate comprises a glass mat, synthetic material layer, a film, or combination thereof.

In embodiments of the cover board, the scrim material comprises polyester, glass, polyester/glass hybrid, nylon, polypropylene, or combinations thereof.

In embodiments of the cover board, the reinforcing layer further includes a surface treatment comprising an acrylic, polyurethane, silicone, or a combination thereof.

In embodiments of the cover board, the core comprises a high density polyisocyanurate.

In embodiments of the cover board, the at least one facer comprises paper, glass, plastic, or combination thereof, and further comprises an adhesive applied between the facer and the scrim material.

According to other aspects of the disclosure, a method is provided comprising obtaining a cover board, the cover board comprising: a core formed from a high density polyisocyanurate; a reinforcing layer positioned over the core, the reinforcing layer comprising a scrim material comprising a woven material, non-woven material, mesh material, or combination thereof; and a facer covering the reinforcing layer and the core; wherein an impact resistance of the cover board is greater than an impact resistance of an identical cover board without the scrim material; obtaining an insulation panel comprising polyisocyanurate; attaching the cover board and the insulation panel to a roof substrate such that the insulation panel is positioned between the cover board and the roof substrate; and applying a membrane over the cover board and the insulation panel to form a roofing system, the membrane comprising thermoplastic polyolefin, polyvinyl chloride, ethylene propylene diene monomer rubber or combination thereof; wherein the roofing system meets FM Approvals ANSI/FM 4470 VSH impact resistance testing standard for very severe hail resistance.

In embodiments of the method, the scrim material comprises a 1000×1000 denier material; and wherein in some embodiments, the scrim includes a plurality of strands arranged in a side-by-side pattern, over/under pattern, tri-directional pattern, quad-directional pattern, or a combination thereof.

In embodiments of the method, the cover board further comprises an adhesive material between the core and the reinforcing layer, and a second facer covering a bottom surface of the core opposite the reinforcing layer.

In another aspect, a roofing system comprises a roof substrate; an insulation panel comprising polyisocyanurate positioned over the roof substrate; a cover board positioned over the insulation panel, the cover board comprising a core having an upper surface and a lower surface; a facer applied over the upper surface of the core and comprising an upper surface and a lower surface; and a reinforcing layer adhesively attached to at least one of the upper or lower surface of the facer, the reinforcing layer comprising a scrim material and a membrane attached to the reinforcing layer, wherein the roofing system meets FM Approvals ANSI/FM 4470 VSH impact resistance testing standard for very severe hail resistance.

In embodiments of the roofing system, the membrane comprises thermoplastic polyolefin, polyvinyl chloride, ethylene propylene diene monomer rubber, or combination thereof.

In embodiments of the roofing system, the core comprises a high density polyisocyanurate.

In embodiments of the roofing system, the scrim material comprises a side-by-side pattern, over/under pattern, tri-directional pattern, quad-directional pattern, or combination thereof.

In embodiments of the roofing system, the reinforcing layer further comprises a substrate attached to the scrim material, the substrate including a glass mat, synthetic material layer, a film, or combination thereof.

In embodiments of the roofing system, the scrim material comprises polyester, glass, polyester/glass hybrid, nylon, polypropylene, or combinations thereof.

In embodiments of the roofing system, the scrim material further includes a surface treatment comprising an acrylic, polyurethane, silicone, or combination thereof.

Accordingly, embodiments of cover boards, roofing systems and methods for forming cover boards that are directed to the above discussed and other needs are disclosed. The foregoing and other advantages and aspects of the embodiments of the present disclosure will become apparent and more readily appreciated from the following detailed description, taken in conjunction with the accompanying drawings. Moreover, it is to be understood that both the foregoing summary of the disclosure and the following detailed description are exemplary and intended to provide further explanation without limiting the scope of the present disclosure.

### BRIEF DESCRIPTION OF THE DRAWINGS

The accompanying drawings, which are included to provide a further understanding of the embodiments of the present disclosure, are incorporated in and constitute a part of this specification, illustrate embodiments of this disclosure, and together with the detailed description, serve to explain the principles of the embodiments discussed herein. No attempt is made to show structural details of this disclosure in more detail than may be necessary for a fundamental understanding of the exemplary embodiments discussed herein and the various ways in which they may be practiced.

FIG. 1A and FIG. 1B show a cover board according to embodiments of the present disclosure.

FIG. 2A and FIG. 2B show another cover board according to additional embodiments of the present disclosure.

FIG. 3 shows yet another cover board according to an embodiment of the present disclosure.

FIG. 4A and FIG. 4B show another cover board according to an embodiment of the present disclosure.

FIG. 5A, FIG. 5B, FIG. 5C, FIG. 5D, and FIG. 5E show various scrim material patterns for use with a cover board according to principles of the present disclosure.

FIG. 6 shows a roofing system with a reinforced cover board according to an embodiment of the present disclosure.

FIGS. 7A-7B illustrate a cover board according to the present disclosure and a conventional cover board after each cover board has been subjected to FM Approvals ANSI/FM 4470 VSH impact resistance testing for very severe hail resistance.

### DETAILED DESCRIPTION

The embodiments of the present disclosure will now be described in more detail with reference to the attached drawing figures.

The present disclosure is directed to cover boards for use in roofing systems, for example, but without limitation, single ply roofing systems, that may be exposed to impacts such as from hail, and in particular, very severe hail. For a roofing system to achieve certification or classification as a hail resistant roofing system, including to be achieve a “Very Severe Hail” (VSH) certification or classification (Class 4—the most stringent certification), the roofing system and components thereof generally must meet the requirements provided under Factory Mutual (FM)® hail-resistant test method ANSI/FM 4473 “Approval Standard for Single-Ply, Polymer-Modified Bitumen Sheet, Built-Up Roof (BUR) and Liquid Applied Roof Assemblies for use in Class 1 and Noncombustible Roof Deck Construction.” The ANSI/FM 4473 testing for Very Severe Hail Resistance requires the roofing system withstand up to 2-inch ice balls propelled at 152-160 feet per second, resulting in an impact energy of 53-58 ft. lbs. Withstanding such testing may mean, after impact, the roofing system components will not exhibit cracks, dents, and/or other visible damage. Other standards and tests may be utilized to classify hail resistant roofing systems and/or components of such systems, such as ASTM D3746 and/or UL 2218.

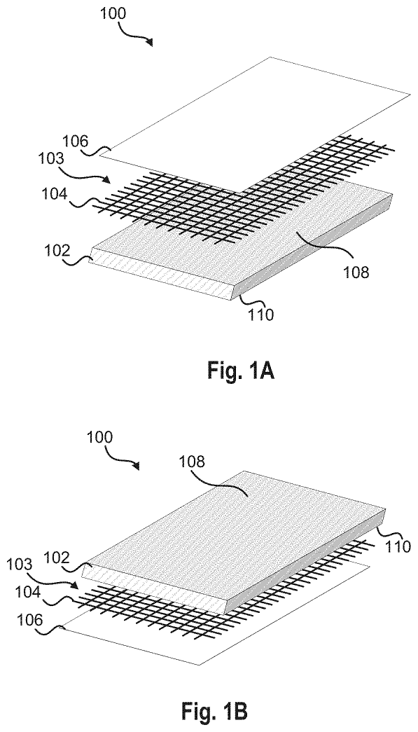

As such, cover boards are described herein and illustrated in FIGS. 1A-7A, that are configured to withstand damage from impacts by hail or other objects and prevent damage from such impacts to other layers of a roofing system. In embodiments, the cover boards include a core with a reinforcing layer applied to at least one of a first and/or second surface of the core. At least one facer may be attached to the first surface, the second surface, or both the first surface and second surface. In embodiments, the reinforcing layer is positioned between the core and the at least one facer. In some embodiments, other layers of different materials also may be disposed or attached to other layers of the cover board. For example, a water-resistant membrane, e.g., a thermoplastic olefin (“TPO”) membrane, may be positioned over or attached to the at least one facer.

In other embodiments, the cover board may include a first reinforcing layer on both sides of the cover board (e.g., a first reinforcing layer may be positioned between a facer and the first surface and another (second) reinforcing layer may be positioned between another facer and the second surface). The cover boards, with the reinforcing layer, as well as a roofing system or roof structure utilizing the cover boards, is configured to withstand impacts from objects including very severe hail.

In embodiments, the reinforcing layer is comprised of a scrim material. The scrim material may comprise a woven material, non-woven material, mesh material, netting or belted materials, or combination thereof. The scrim material may further be comprised of polyester, glass, polyester/glass hybrid, nylon, polypropylene, or some combinations thereof.

In embodiments, the scrim material may comprise various patterns, such as an over/under pattern, tri-directional pattern, quad-directional pattern, or some combination thereof. In embodiments, the scrim material can be attached to a substrate or supporting backing material; and can attached to the core via an adhesive or mechanical connection.

FIGS. 1A-6 show embodiments of roofing systems including cover boards 100, 200, 300, 400, and example embodiments of scrim materials 104 for the reinforcing layers 103 for such cover boards according to the present disclosure. As shown in FIG. 1A and FIG. 1B, in an embodiment a cover board 100, such as for use in a roofing system, includes a core 102, a reinforcing layer 103, and at least one facer 106.

The core 102 includes a first surface 108 and a second surface 110 opposite the first surface 108. In embodiments, the core 102 may be comprised of a polymeric material, polyisocyanurate, high density polyisocyanurate, structural foam materials, flexible polyurethane foams, high resiliency polyurethane foams, combustion modified high resiliency foams, non-polyurethane cushioning foams, as well as other materials suitable for use in a roofing application, or some combinations thereof. For example, and without limitation, in embodiments, the cover board 100 can include an EnergyGuard™ HD cover board as manufactured by GAF of Parsippany, N.J.

In some embodiments, the core 102 further may include or comprise an insulating material, or can include a layer of insulating material positioned along of the first and/or second surface of the core or a facer applied thereto. The cover board 100 also may include other layers applied thereto to provide different properties such as water resistance (e.g. resistance to passage of water), water shedding (e.g. facilitating flowing of water away from the cover board 100 or roofing system or structure), (e.g. deterring pooling or ponding of water along the cover board 100 and/or along the roofing system or structure); and water resistance (e.g., resistance to the passage of water flow therethrough) ultraviolet (UV) light resistance, and other properties in addition to helping enhance the impact resistance of the cover boards.

Still further, in some embodiments, the core 102 also can have added reinforcing materials such as fillers, flakes, fibers, particulates, or combinations thereof. For example, in embodiments, the core 102 can incorporate glass or plastic (including recycled glass or plastic materials) fibers, spheres or particulates, amorphous glass, flakes or particulate of metal such as aluminum, mica, carbon fibers, boron fibers, aramid and/or polyaramid fibers, carbon nanotubes, graphene, calcium carbonate materials, oxides such as aluminum oxide, calcium oxide, etc., silica, clay, and other mineral and recycled materials. Such reinforcing materials can be added during the forming process for the core.

In embodiments, the core 102 can comprise a lightweight panel having a thickness of ½ inch to 3 inches, ½ inch to 2½ inches, ½ inch to 2 inches, ½ inch to 1½ inches, ½ inch to 1 inch, and/or 2 inch to % inches. Other thicknesses also can be used.

In embodiments, the reinforcing layer 103 can be positioned between the facer 106 and the first surface 108 of the core 102 or between the facer and second surface 110 of the core 102. In other embodiments, the cover board 100 may include a facer 106 applied on both the first and second surfaces at the core 102 and can include a reinforcing layer 103 positioned along both the first and second surfaces of the core 102.

In embodiments, the reinforcing layer 103 will be applied to or adhered to the first surface 108 and/or second surface 110 of the core 102, such as by application of an adhesive to the reinforcing layer 103 or to the core 102. In embodiments where an adhesive is applied to the reinforcing layer or is utilized to attach the reinforcing layer 103 to the core 102, after the adhesive is applied, the adhesive may be allowed to cure for a period of time thereby allowing a strong adhesion to the core 102. Prior to, during, or after curing, the facer 106 may be applied over the reinforcing layer 103. By way of example only, in embodiments, a contract type adhesive such as GAF EnergyGuard™ PVC adhesive from GAF of Parsippany, N.J., can be used. Other adhesive also can be used. In other embodiments, the reinforcing layer 103 can be attached to the core 102 by fasteners or other mechanical connections.

In some embodiments, the reinforcing layer 103 can be attached to the facer 106 prior to installation or application of the facer 106 and reinforcing layer 103 to the core 102. For example, the facer can include an upper surface that faces away from the core, and a lower surface oriented so as to face toward the core 102, and to which the reinforcing layer can be attached. In such an embodiment, the reinforcing layer 103 may be applied to the facer 106 during manufacturing of the facer 106 and can be attached to the lower surface of the facer 106 via an adhesive material. The reinforcing layer 103 and facer 106, as a composite sheet or film, then may be applied to the core 102. The reinforcing layer 103 and facer 106 may be applied to the core 102 in a factory or manufacturing setting, or can be applied in the field, prior to installation or application in a roofing system.

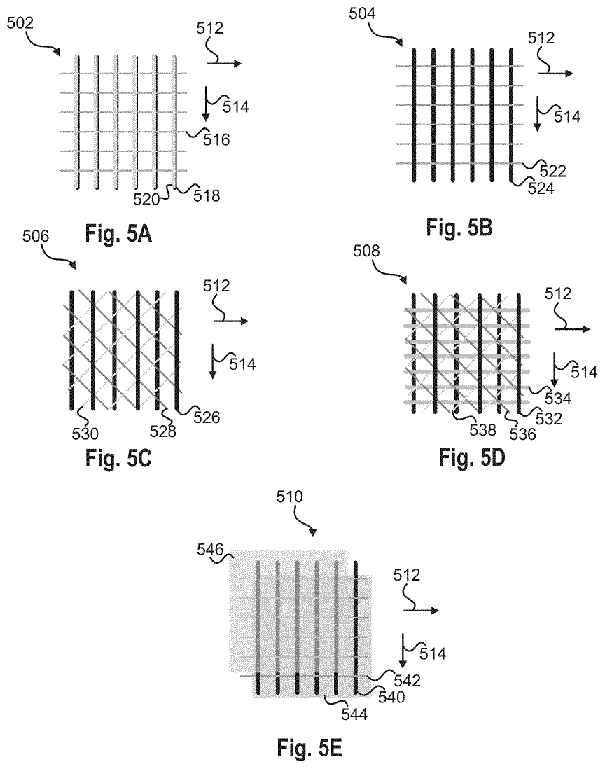

In embodiments, the scrim material 104 for the reinforcing layer can comprise materials, such as, for example, polyester, glass, fiberglass, nylon, polypropylene, and/or combinations thereof; and may include woven materials, non-woven materials, mesh materials, netting, belted materials, or some combination thereof. Non-limiting example embodiments scrim materials 104, as illustrated in and further described below in relation to FIGS. 5A-5E, can include scrim materials formed with various patterns and/or configurations, including, but not limited to, a side-by-side patterns, over/under patterns, tri-directional patterns, quad-directional patterns, and/or complex patterns. In some embodiments, different pattern scrim materials can be stocked or overlaid to form a multi-component reinforcing layer 103.

In embodiments, the scrim material 104 may comprise a sheet material, woven or non-woven mat, metal, netting, mesh, or a combination thereof, which scrim material can have a having a denier of 500×500, 1000×1000, 1000×1100, 200×1200, 1300×13000, 1400×1400, or greater. In some embodiments, the denier of the scrim material 104 may be based on a region or use application of the cover board 100, and as such, cover boards 100 with a particular scrim material 104 denier may be classified for different regions and labeled appropriately. In embodiments, the scrim material 104 may comprise a thickness of 0.25 mm to 2 mm, 0.5 mm to 2 mm, 0.75 mm to 2 mm, 1.25 mm to 2 mm, 1.50 mm to 2 mm, 0.25 mm to 1.5 mm, 0.5 mm to 1.5 mm, 0.75 mm to 1.5 mm, 1 mm to 1.5 mm, 0.25 mm to 1.25 mm, 0.5 mm to 1.25 mm, 0.75 mm to 1.25 mm, 1 mm to 1.25 mm, 0.25 mm to 1 mm, 0.25 mm to 1 mm, 0.5 mm to 1 mm, 0.75 mm to 1 mm, 0.25 mm to 0.75 mm, 0.5 mm to 0.75 mm, or 0.25 mm to 0.5 mm. Other thicknesses also can be used.

In embodiments, the facer 106 applied to the first surface of the core 102, and/or the facer 106 applied to the second surface of the core 102 (as indicated in FIG. 1B) may comprise paper, glass, a glass reinforced material, a coated glass material, perlite, cellulosic fiber, oriented strand board, plywood, other materials suitable for roofing systems, and/or combination thereof. In an embodiment, the facer 106 may include a sheet or film. The facer 106 further may be various thicknesses; including 1 mm to 5 mm, 1 mm to 4 mm, 1 mm to 3 mm, 1 mm to 2 mm, 2 mm to 5 mm, 2 mm to 4 mm, 2 mm to 3 mm, 3 mm to 5 mm, 3 mm to 4 mm, or 4 mm to 5 mm. In embodiments, the core 102 may comprise a thickness of 1 mm to 15 mm, 5 mm to 15 mm, 10 mm to 15 mm, 1 mm to 10 mm, 5 mm to 10 mm, or 1 mm to 5 mm.

As illustrated in FIG. 1A, the facer 106 and reinforcing layer 103 may be attached to the first surface 108 of the core 102 of the cover board 100. As illustrated in FIG. 1B, the facer 106 and reinforcing layer 103 may be attached to the second surface 110 of the core 102 of the cover board 100. As noted above in some embodiments, a facer 106 may be attached to both the first surface 108 and the second surface 110, and in some embodiments, a reinforcing layer 103 may be positioned between one of the first or second surfaces of the core and the lower surface of the facer applied thereto, or between both the first surface 108 of the core and the lower surface of the facer 106 applied over the first surface of the core, and between the second surface 110 of the core and the upper surface of the facer 106 applied to the second surface of the core, as indicated in FIG. 1B.

As described herein, the cover board 100 is configured to withstand severe hail, very severe hail, and/or other types of impact, and exhibiting an impact resistance greater than an impact resistance of an identical cover board without the reinforcing layer 103 or scrim material 104. The addition of the reinforcing layer 103 enables the cover board 100 to meet and/or exceed standards for achieving a very severe hail (VSH) certification from Factory Mutual (FM)®. The FM Approvals ANSI/FM 4470 VSH impact resistance testing standard for very severe hail resistance test includes propelling 2-inch ice balls at 152-160 feet per second, resulting in an impact energy of 53-58 ft. lbs., at the cover board 100. If the cover board 100 does not experience substantial cracks or other damage on either side of the cover board 100 during such testing, which could cause leaks or failures of the other cover boards, then the cover board 100 or other material is rated as able to withstand “Very Severe Hail.” Other tests, standards, and/or classifications, such as ASTM D3746, and/or UL 2218, also may be utilized or used to determine hail resistance of the cover board 100. In addition, the cover board 100 with the reinforcing layer 103 generally will exhibit an impact resistance greater than an impact resistance of an identical cover board without the reinforcing layer 103.

In addition, in some embodiments, the reinforcing layer 103 further may be treated with a surface treatment to increase compatibility with, attach ability to, and/or to help increase overall impact resistance (e.g., VSH rating) of the cover board 100. Such surface treatments may include applying a protective coating such as an acrylic, polyurethane, silicone material, a rubberized coating, or combination thereof to the reinforcing layer 103. The surface treatment will be configured to provide the reinforcing layer 103 with selected properties, as well as help enhance resistance at the cover board 100 to impacts. For example, the surface treatment may provide water shedding properties for the cover board 100 (e.g., facilitating flowing of water away from the cover board 100 roof structure); water resistance for the cover board and a roof structure of which it is a part (e.g., resistance to the passage of water flow therethrough), and UV protection.

In embodiments, one or more surface treatments may be applied to the reinforcing layer 103. For example, a surface treatment may be applied to the reinforcing layer 103, allowed to cure, and the process repeated one or more times, to apply multiple surface treatments. Such a surface treatment may be applied to the reinforcing layer 103 prior to, during, or after attachment or application to the core 102 or facer 106.

Still further, in embodiments, the surface treatment configured to provide shock absorption or dampening effects to help absorb, dissipate and/or spread energy from impacts of objects such as very severe hail can be applied over an outer facing surface of the facer 106; applied between the facer 106 and the reinforcing layer 103, or applied both on top of the facer and between the facer and reinforcing layer. Such surface treatment can, in various embodiments, comprise a protective coating, sheet, film or mat formed from acrylic, polyurethane, silicone material, a rubber, polyester, polyvinyl alcohols, polyurea, epoxy/amine, polyamide, or combinations thereof.

In still other embodiments, the facer can incorporate similar properties; for example, being formed from an energy absorbing material such as a rubberized mat, or include an energy absorbing material embedded therein, so as to be able to flex and absorb and/or dissipate at least some of the impact energy from impacts from very severe hail and other objects before such impact energy reaches the core of the cover board.

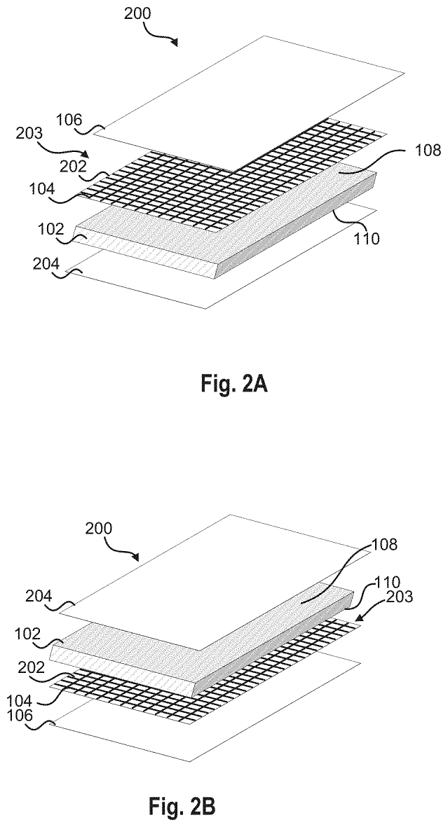

In an additional embodiment of a cover board 200 such as illustrated in FIG. 2A and FIG. 2B, a reinforcing layer 203 is attached to the core 102, and includes a scrim material 104 attached or connected to a substrate 202 or other support layer, separate from or in addition to the facer 106. The substrate 202 may be a sheet or film of varying thicknesses. For example, the substrate 202 may comprise a thickness of 1 mm to 5 mm, 1 mm to 4 mm, 1 mm to 3 mm, 1 mm to 2 mm, 2 mm to 5 mm, 2 mm to 4 mm, 2 mm to 3 mm, 3 mm to 5 mm, 3 mm to 4 mm, or 4 mm to 5 mm.

In embodiments, the substrate 202 may be comprised of a glass mat, a synthetic material layer, a film, or combinations thereof. In such embodiments, the reinforcing layer 203 (e.g., the substrate 202 and the scrim material 104 attached to the substrate 202) can be attached to or connected to the core 102. The substrate 202 may be oriented or positioned so as to in contact with one of the surfaces of the core 102, while the scrim material 104 may face away from the core 102 (e.g., the scrim material 104 may not be in direct contact with the surface of the core 102), or the scrim material 104 may be oriented or positioned so as to contact the core 102, while the substrate 202 may face away from the core 102. In embodiments, the substrate, scrim material and/or the facer that is in contact with the core 102 may be attached, via an adhesive or by a mechanical connection, such as fasteners, etc. . . . to the core 102.

As illustrated in FIG. 2A, in embodiments, the facer 106 and reinforcing layer 203 may be attached or connected to the first surface 108 of the core 102, and another facer 204 may connect to the second surface 110 of the core 102. In such embodiments, the facer 204 may be comprised of the same material as facer 106, or can comprise a material different from that of the material of facer 106.

As illustrated in FIG. 2B, in embodiments, the facer 106 and reinforcing layer 203 may be attached to the second surface 110 of the core 102, while another facer 204 is attached to the first surface of the core 102 opposite the reinforcing layer 203 facer 204.

In embodiments, the cover boards 100 (FIGS. 1A-1B) and 200 (FIGS. 2A-2B) may be utilized in Single-Ply roof assemblies, Polymer-Modified Bitumen Sheet roof assemblies, Built-Up Roof (BUR) roof assemblies, and Liquid Applied roof assemblies. The cover boards may be installed in the same manner as typical cover board. Depending upon the application, other roofing materials or components further may be applied over the cover boards, e.g., TPO membranes, liquid roofing materials, resins, sealants, and/or other suitable roofing materials or components, or combinations thereof.

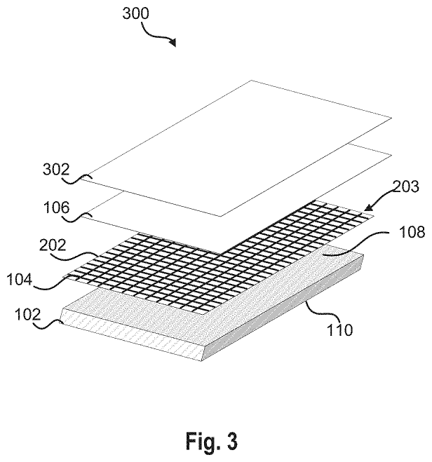

FIG. 3 illustrates another embodiment of a cover board 300. The cover board 300 is similar to the cover boards 100 and 200, illustrated in FIGS. 1A-2B. The cover board 300 of the embodiment shown in FIG. 3 can include the same or similar components to those described above, but further includes a membrane 302 covering the facer 106 applied to the first surface of the core. The membrane 302 can include a water-resistant roofing membrane sheet comprised of thermoplastic polyolefin (TPO), polyvinyl chloride, ethylene propylene diene monomer rubber, or combinations thereof.

In embodiments, the membrane 302 may have a thickness of 50 mils to 200 mils, 50 mils to 150 mils, 50 mils to 125 mils, and 50 mils to 100 mils, 50 mils to 90 mils, 50 mils to 80 mils, 50 mils to 70 mils, 50 mils to 60 mils, 60 mils to 200 mils, 60 mils to 150 mils, 60 mils to 125 mils, 60 mils to 100 mils, 60 mils to 90 mils, 60 mils to 80 mils, 60 mils to 70 mils, 70 mils to 200 mils, 70 mils to 150 mils, 70 mils to 125 mils, 70 mils to 100 mils, 70 mils to 90 mils, 70 mils to 80 mils, 80 mils to 200 mils, 80 mils to 150 mils, 80 mils to 125 mils, 80 mils to 100 mils, 80 mils to 90 mils, 90 mils to 200 mils, 90 miles to 150 mils, 90 mils to 125 mils, 90 mils to 100 mils, 100 mils to 200 mils, 100 mils to 150 mils, 100 mils to 125 mils, or other thicknesses.

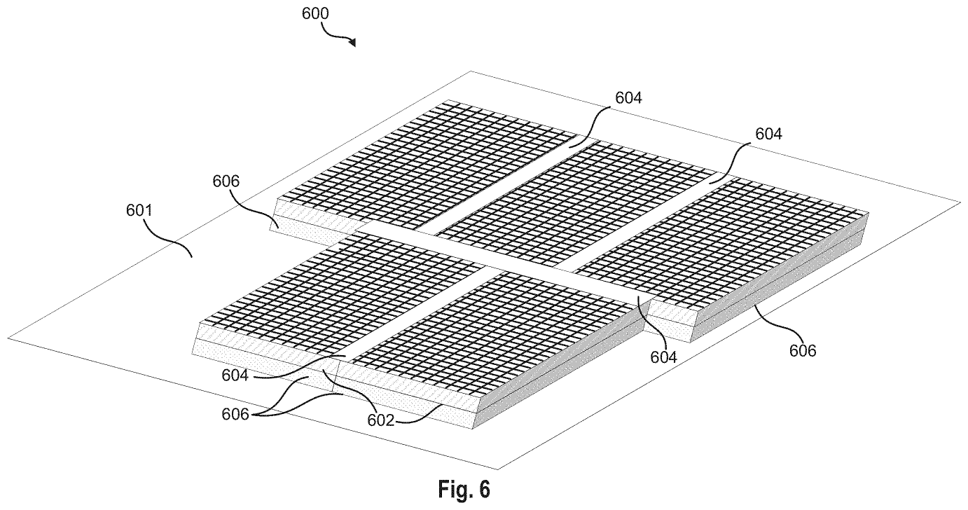

Such a membrane 302 may be applied in the field or during manufacturing. For example, after one or more cover boards 300 are installed in a roofing system (See FIG. 6), the membrane 302 may be applied over the cover board 300 (e.g., over an upper surface of a facer of the cover board) for several purposes. The membrane 302 may offer a number of benefits, such as water shedding (e.g. facilitating flowing of water away from the cover board 300 or roofing system or structure); resistance to water ponding (e.g. deterring pooling or ponding of water along the cover board 300 and/or along the roofing system or structure); and water resistance (e.g., resistance to the passage of water flow therethrough); ultraviolet (UV) light resistance, or combinations thereof, in addition to helping enhance impact resistance of the cover boards.

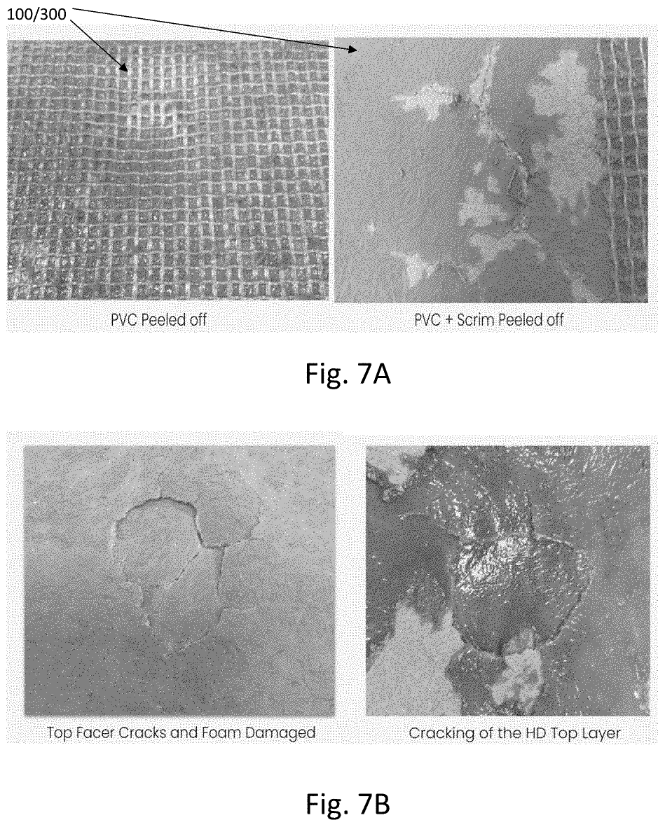

For example, and not limitation, FIGS. 7A-7B illustrate an example cover board 100 (FIG. 7A) according to the present disclosure and conventional cover boards (7B) that have been subjected to FM Approvals ANSI/FM 4473 VSH impact resistance testing for very severe hail. The cover board 100 shown in FIG. 7A comprised a ½″ core with a reinforcing layer including a PVC scrim material and a facer, and with 60 mil PVC membrane applied over the facer. The conventional cover boards as shown in FIG. 7B included a ½″ foam core with a facer applied thereover; and a cover board with a ½″ core, a facer over the core, and a 60 mil PVC membrane applied on top. As illustrated in FIG. 7A, after testing, the cover board 100/300 was able to withstand the impact of the 2″ ice ball, with minimal impression or signs of impact and no signs of cracking in the core after the PVC scrim material and PVC membrane are peeled back; while the cover boards shown in FIG. 7B exhibited significant cracking and damage to the facer and foam core.

In some embodiments, the application of the facer can include applying a coating of a roofing adhesive to one surface of the facer and/or a surface of the reinforcing layer. For example, in embodiments, the facer with the reinforcing layer already applied thereto can be applied as a slipsheet positioned along a core, and a roofing adhesive can be applied over the reinforcing layer, followed by a TPO or PVC membrane applied thereover.

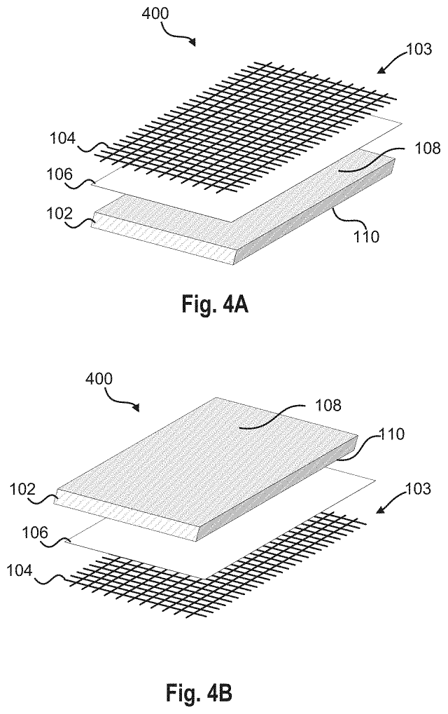

In other embodiments of a cover board such as illustrated at 400 in FIG. 4A and FIG. 4B, the reinforcing layer 103 may be applied over the facer 106. In an embodiment, the facer 106 may be attached to the first surface 108 and/or the second surface 110 of the core 102. The reinforcing layer 103 may then be applied over the facer 106, such as by applying a coating of roofing adhesive to the facer and allowing the roofing adhesive to cure. A membrane (e.g., membrane 302 as shown in FIG. 3) may be applied over the reinforcing layer 103. In another embodiment, the reinforcing layer 103 may first be attached to the facer 106 and then attached to the roof deck. In other words, the facer 106 and reinforcing layer 103 may comprise a single sheet installed or applied to the first surface 108 and/or second surface 110 of the core 102 of a cover board 400.

In embodiments as illustrated in FIG. 4A, the facer 106 may be attached or connected to the first surface 108 of the core 102. The reinforcing layer 103 may be applied over the facer 106 as noted above. As illustrated in FIG. 4B, the facer 106 may be attached or connected to the second surface 110 of the core 102. The reinforcing layer 103 may be applied over the facer 106 as noted above. In another embodiment, the facer 106, with or without the reinforcing layer 103, may be applied to the first surface 108 and/or the second surface 110. In some embodiments where a facer 106 is applied to both the first surface 108 and the second surface 110, the reinforcing layer 103 may be applied over one or both facers 106.

In embodiments, the facer 106, or the facer 106 and reinforcing layer 103 together, can be attached to the core 102 by an adhesive, fasteners, or a combination thereof. For example, in a factory setting, the facer can be attached to the reinforcement layer as part of an overall manufacturing process for the cover board. In embodiments, the reinforcing layer can be applied on top of or along the bottom of the facer.

As shown in FIG. 5A, FIG. 5B, FIG. 5C, FIG. 5D, and FIG. 5E, various scrim material 104 patterns are illustrated. The scrim material 104 of the reinforcing layer may be configured or constructed in a variety of patterns, not limited to the patterns illustrated, and including other patterns not shown. With regard to the following discussion of the various example scrim material patterns such as shown in FIGS. 5A-5E, the terms “yarn” and “yarns” are not to be taken as limiting the scrim to particular materials or constructions; and shall be understood to include single ply and multi-ply yarns, twisted yarns, textured yarns, filaments, fibers, threads, wires, cords, and combinations thereof.

As illustrated in FIG. 5A, in an embodiment, the scrim material can have a pattern may be configured as a side-by-side pattern 502. In such a side-by-side pattern 502, a first plurality of yarns 518 and a second plurality of yarns 520 may be set in a machine direction 514. Further the first and second yarns 518 and 520 may be positioned one on top of the other. A third plurality of yarns 516 may be set between the first and second yarns 518 and 520 at a 90° angle in relation to the first and second yarns 518 and 520. The first and second yarns 518 and 520 also may be laid next to each other in a machine direction 514 in an alteration or offset arrangement, while the third yarns 516 may be laid in a cross-machine direction 512.

As illustrated in FIG. 5B, in embodiments, the scrim material may be formed with an over/under pattern 504. In such an over/under pattern 504 yarns from two warp sheets may lie directly on top of each other. In the over/under pattern 504, a first plurality of a machine direction yarns 524 may lie over and underneath, in an alternating series, a second plurality of yarns 522 that extend in a cross-machine direction. Such an over/under pattern 504 may offer increased dimensional stability.

As illustrated in FIG. 5C, in embodiments the scrim material may be formed with a tri-directional pattern 506. In such a tri-directional pattern 506, angled yarns 528, 530 are added in an over/under alternating pattern in relation with a machine direction yarn 526 to provide redistributed strength. Further, such a tri-directional pattern 506 may be utilized for aesthetic purposes. As illustrated in FIG. 5D, in embodiments, the scrim material may be formed with a quad-directional pattern 508. In such a quad-directional pattern 508, two sets of angled yarns 536, 538 may be included with a set of cross-machine direction yarns 534 and a series of machine direction yarns 532. Such added diagonal yarns 536, 538 may further increase dimensional strength.

As illustrated in FIG. 5E in embodiments, the scrim material may be formed with a complex pattern 510. In such a complex pattern 510, a substrate 544 may be utilized and positioned under cross-machine direction yarns 542 and machine direction yarns 540. The substrate 544 may be comprised of a glass mat, synthetic film, a film, and/or some combination thereof. The substrate 544 may be attached to or connected to the cross-machine direction yarns 542 and the machine direction yarns 540. Another substrate 546 may overlie or be positioned over the cross-machine direction yarns 542 and machine direction yarns 540. The substrate 546 may be comprised of the same or of a different material of substrate 544.

In embodiments, the substrate 546 may be attached to or connected to the top of the cross-machine direction yarns 542 and machine direction yarns 540. With such a pattern or arrangement of yarns, any of the scrim material patterns described and illustrated herein or any other patterns may be utilized in conjunction with the substrate 544 and substrate 546, e.g., each substrate 544, 546 comprising a glass mat, a synthetic film, a film, and/or some combination thereof. Further, the yarns in each of the scrim material patterns may be chemically or thermally bonded. In a further embodiment, the scrim material patterns and process of adding reinforcing layers to a cover board may increase the overall strength or impact resistance of a cover board at a low cost.

In FIG. 6, a roofing system with a reinforced cover board according to the principles of the present disclosure is illustrated. In such embodiments, it will be understood that any of the cover boards described above may be utilized in such an embodiment and, solely for illustrative purposes, the cover board is shown with the reinforcing layer exposed.

In an embodiment, the roofing system 600 may include a deck or roofing substrate 601. The deck or roofing substrate 601 may be comprised of one or more materials, such as wood (sheets or beams), cement-based materials, polymeric materials, polyisocyanurate, and/or any other suitable material for a roofing system. The substrate 601 may be the first material or component installed in or applied to a roofing system.

After installation of the deck or roofing substrate 601 one or more insulation panels 606 may be installed or positioned over the deck or roofing substrate 601. Such an insulation panel 606 may be comprised of polyisocyanurate, wood, foam, and/or other insulating material. The insulation panels 606 may be attached to the deck or roofing substrate 601 mechanically and/or adhesively.

After the insulation panels 606 are positioned over the deck or roofing substrate 601, cover boards 602 may be positioned over the insulation panels 606. Similarly, the cover boards 602 may be mechanically and/or adhesively attached to the insulation panel 606. After positioning the one or more cover boards 602 over the insulation panels 606, joints may be formed. The joints may be covered by tape 604, which can include a polymer membrane material. After covering the joints, a membrane material that can have protective properties such as water shedding, water resistance, UV resistance, and other properties and/or combinations thereof, such as a TPO membrane or other polymer membrane, or a liquid roofing material coating, or combinations thereof, may be applied over the entire assembly or roofing system 600.

The present disclosure has been described herein in terms of examples that illustrate principles and aspects of the present disclosure. The skilled artisan will understand, however, that a wide gamut of additions, deletions, and modifications, both subtle and gross, may be made to the presented examples without departing from the spirit and scope of the present disclosure.

1. A cover board, comprising:
a core having a first surface and a second surface, the core configured to overlie a roof substrate;
at least one facer attached to the first surface, the second surface, or the first surface and second surface of the core; and
a reinforcing layer positioned between the core and the at least one facer;
wherein the reinforcing layer comprises a scrim material;
wherein the scrim material comprises a woven material, non-woven material, mesh material, or combination thereof, and
wherein an impact resistance of the cover board is greater than an impact resistance of an identical cover board without the scrim material.

2. The cover board of claim 1, wherein, when the cover board is installed on a roof substrate to form a roofing system, the roofing system meets FM Approvals ANSI/FM 4470 VSH impact resistance testing standard for very severe hail resistance.

3. The cover board of claim 1, wherein the scrim material comprises a denier of at least 1000×1000 material.

4. The cover board of claim 1, wherein the scrim material comprises a side-by-side pattern, over/under pattern, tri-directional pattern, quad-directional pattern, or combination thereof.

5. The cover board of claim 1, wherein the reinforcing layer further comprises a substrate attached to the scrim material.

6. The cover board of claim 5, wherein the substrate comprises a glass mat, synthetic material layer, a film, or combination thereof.

7. The cover board of claim 1, wherein the scrim material comprises polyester, glass, polyester/glass hybrid, nylon, polypropylene, or combinations thereof.

8. The cover board of claim 1, wherein the reinforcing layer further includes a surface treatment comprising an acrylic, polyurethane, silicone, or combination thereof.

9. The cover board of claim 1, wherein the core comprises a high density polyisocyanurate.

10. The cover board of claim 1, wherein the at least one facer comprises paper, glass, plastic or combination thereof, and further comprises an adhesive applied between the facer and the scrim material.

11. A method comprising:
obtaining a cover board, the cover board comprising:
a core formed from a high density polyisocyanurate;
a reinforcing layer positioned over the core, the reinforcing layer comprising a scrim material comprising a woven material, non-woven material, mesh material, or combination thereof; and
a facer covering the reinforcing layer and the core;
wherein an impact resistance of the cover board is greater than an impact resistance of an identical cover board without the scrim material;
obtaining an insulation panel comprising polyisocyanurate;
attaching the cover board and the insulation panel to a roof substrate such that the insulation panel is positioned between the cover board and the roof substrate; and
applying a membrane over the cover board and the insulation panel to form a roofing system, the membrane comprising thermoplastic polyolefin, polyvinyl chloride, ethylene propylene diene monomer rubber, or combination thereof;
wherein the roofing system meets FM Approvals ANSI/FM 4470 VSH impact resistance testing standard for very severe hail resistance.

12. The method of claim 11, wherein the scrim material is a 1000×1000 denier material including a plurality of strands arranged in a side-by-side pattern, over/under pattern, tri-directional pattern, quad-directional pattern, or combination thereof.

13. The method of claim 11, wherein the cover board further comprises an adhesive material between the core and the reinforcing layer, and a second facer covering a bottom surface of the core opposite the reinforcing layer.

14. A roofing system, comprising:
a roof substrate;
an insulation panel comprising polyisocyanurate positioned over the roof substrate;
a cover board positioned over the insulation panel, the cover board comprising:
a core having a first surface and a second surface;
a facer applied over the first surface of the core and comprising an upper surface and a lower surface; and
a reinforcing layer adhesively attached to at least one of the upper or lower surface of the facer, the reinforcing layer comprising a scrim material; and
a membrane attached to the reinforcing layer;
wherein the roofing system meets FM Approvals ANSI/FM 4470 VSH impact resistance testing standard for very severe hail resistance.

15. The roofing system of claim 14, wherein the membrane comprises thermoplastic polyolefin, polyvinyl chloride, ethylene propylene diene monomer rubber, or combination thereof.

16. The roofing system of claim 14, wherein the core comprises a high density polyisocyanurate.

17. The roofing system of claim 14, wherein the scrim material comprises a side-by-side pattern, over/under pattern, tri-directional pattern, quad-directional pattern, or combination thereof.

18. The roofing system of claim 14, wherein the reinforcing layer further comprises a substrate attached to the scrim material, the substrate including a glass mat, synthetic material layer, a film, or combination thereof.

19. The roofing system of claim 14, wherein the scrim material comprises polyester, glass, polyester/glass hybrid, nylon, polypropylene, or combinations thereof.

20. The roofing system of claim 14, wherein the scrim material further includes a surface treatment comprising an acrylic, polyurethane, silicone, or combination thereof.
